(19) United States
(12) Patent Application Publication
(10) Pub. No.: US 2024/0140628 A1
(43) Pub. Date: May 2, 2024

(54) SYSTEM AND METHOD FOR CHARGING UNMANNED AERIAL VEHICLES

(71) Applicant: HERE Global B.V., Eindhoven (NL)

(72) Inventors: Donta WHITE, Racine, WI (US); Leon STENNETH, Chicago, IL (US); Adekunle AFOLABI, Aurora, IL (US)

(21) Appl. No.: 17/977,696

(22) Filed: Oct. 31, 2022

(51) Int. Cl. B64U 50/37; B64U 20/87; B64U 70/97; G06V 10/774; G06V 20/70; H02J 7/00

(52) U.S. Cl. CPC B64U 50/37; B64U 20/87; B64U 70/97; G06V 10/774; G06V 20/70; H02J 7/0048; B64U 2101/30

(57) ABSTRACT

A system, a method, and a computer program product may be provided for charging an unmanned aerial vehicle (UAV). The system may include a memory configured to store computer executable instructions and a processor configured to execute the computer executable instructions to obtain a set of UAV attributes and location information associated with an UAV, identify a plurality of electric power lines in proximity of the UAV based on the location information, obtain a set of electric power line attributes for the plurality of electric power lines, and identify one or more electric power lines from the plurality of electric power lines based on the set of UAV attributes, the set of electric power line attributes and a trained first machine learning model. The processor is configured to direct the UAV to the identified one or more electric power lines for charging the UAV.

### TECHNOLOGICAL FIELD

The present disclosure generally relates to charging of unmanned aerial vehicles (UAVs), and more particularly relates to charging of UAVs by electrical power lines.

### BACKGROUND

Unmanned aerial vehicles (UAVs) are capable of drawing electricity from electrical power sources and storing the energy to power one or more electric motors. Typically, UAV are charged at, for example, home, fleet facilities, and public charging stations. With widespread adoption of UAVs, public charging infrastructure is rapidly expanding.

However, the expansion of the charging infrastructure is at a slower pace as compared to a scale of adoption of UAVs. As a result, UAV owners may face problems, such as overcrowding, slow charging, long waiting, etc., at public charging stations. Therefore, UAVs may require alternative charging options for fast and reliable charging.

### BRIEF SUMMARY

A system, a method, and a computer program product are provided herein that focuses on charging an unmanned aerial vehicle (UAV). In one aspect, the system for charging an unmanned aerial vehicle (UAV) may be provided. The system may include a memory configured to store computer executable instructions; and one or more processors (hereinafter referred as processor) configured to execute the instructions to obtain a set of UAV attributes and location information associated with the UAV. In accordance with an embodiment, the processor may be configured to identify a plurality of electric power lines in proximity of the UAV, based on the location information. In accordance with an embodiment, the processor may be configured to obtain a set of electric power line attributes for the plurality of electric power lines. In accordance with an embodiment, the processor may be configured to identify one or more electric power lines from the plurality of electric power lines based on the set of UAV attributes, the set of electric power line attributes and a trained first machine learning model. In accordance with an embodiment, the processor may be configured to direct the UAV to the identified one or more electric power lines for charging the UAV.

According to some example embodiments, the UAV is directed to the electric power lines which is nearest to an original route of the UAV.

According to some example embodiments, the one or more electric power lines are identified from the plurality of electric power lines based on a set of environment attributes.

According to some example embodiments, the processor may be further configured to receive labeled training information relating to charging of one or more UAVs on one or more electric power lines. The labeled training information may include a set of UAV attributes relating to the one or more UAVs, a set of power line attributes relating to the one or more electric power lines, and a set of labels relating to classification of charging. In accordance with an embodiment, the processor may be further configured to determine a plurality of features corresponding to charging of the one or more UAVs on the one or more electric power lines using the labeled training information and train the first machine learning model to label one or more unlabeled test information with a classification label for classification of charging using the plurality of features and the set of labels.

According to some example embodiments, the set of labels may include one or more ground truth labels including at least one of a successful charging and an unsuccessful charging.

According to some example embodiments, the obtaining the set of features may include querying a database for a functional class feature of each of labeled training information, unlabeled test information, or a combination thereof, as at least one of the set of features.

According to some example embodiments, the trained first machine learning model along with the training information is stored locally on the UAV.

According to some example embodiments, the processor may be further configured to receive a first set of images from the UAV and determine a set of image features relating to the first set of images using a trained second machine learning model. In accordance with an embodiment, the processor may be further configured to label the first set of images with at least one of a positive label for presence of the electric power line and a negative label for absence of the electric power line, in the corresponding first set of images, based on the set of image features.

According to some example embodiments, the processor may be further configured to receive a set of labeled historic samples and determine a set of sample features relating to the set of labeled historic samples. The set of labeled historic samples may include positive samples and negative samples associated with one or more electric power lines. In accordance with an embodiment, the processor may be further configured to train the second machine learning model to label one or more unlabeled test samples with at least one of a positive label for presence of an electric power line and a negative label for absence of an electric power line, in the corresponding one or more unlabeled test samples, based on the set of labeled historic samples and the set of sample features.

According to some example embodiments, the first set of images is captured by an imaging source associated with the UAV during a travel

According to some example embodiments, the processor may be further configured to trigger the imaging source associated with the UAV to capture the first set of images based on at least one of the location information, timing information, and battery information associated with the UAV.

Embodiments disclosed herein may provide a method for charging an unmanned aerial vehicle (UAV). The method may include obtaining a set of features for charging of the UAV by an electric power line. The set of features may include a set of UAV attributes and location information associated with the UAV and a set of electric power line attributes relating to the electric power line. The method may include determining a classification label for charging of the UAV by the electric power line, using the set of features and a trained first machine learning model. The method may include generating a charging output associated with the UAV and the electric power line, based on the classification label.

According to some example embodiments, the charging output includes when and where to charge the UAV on the electric power line, when the classification label corresponds to a successful label. According to some other example embodiments, the charging output includes abort charging of the UAV from the electric power line, when the classification label corresponds to an unsuccessful label.

According to some example embodiments, method may further include receiving a first set of images from the UAV and determining a set of image features relating to the first set of images using a trained second machine learning model. The method may further include labeling the first set of images with at least one of a positive label for presence of the electric power line or a negative label for absence of the electric power line, in the corresponding first set of images, based on the set of image features.

According to some example embodiments, the first set of images is captured by an imaging source associated with the UAV during a travel.

According to some example embodiments, the method may further include triggering the imaging source associated with the UAV to capture the first set of images based on at least one of the location information, timing information, and battery information associated with the UAV.

Embodiments of the present disclosure may provide a computer programmable product including a non-transitory computer-readable medium having stored thereon computer-executable instructions, which when executed by one or more processors, cause the one or more processors to carry out operations for charging an unmanned aerial vehicle. The operations include receiving labeled training information relating to charging of one or more unmanned aerial vehicles (UAVs) on one or more electric power lines. The labeled training information may include a set of UAV attributes relating to the one or more UAVs, a set of power line attributes relating to the one or more electric power lines, and a set of labels relating to classification of charging. The operations include determining a plurality of features corresponding to charging of the one or more UAVs on the one or more electric power lines, using the labeled training information. The operations include training a first machine learning model to label one or more unlabeled test information with a classification label for classification of charging, using the plurality of features and the set of labels.

According to some example embodiments, the operations may further include obtaining a set of features for charging of an UAV by an electric power line and determining a classification label for charging of the UAV by the electric power line using the set of features and the trained first machine learning model. The set of features may include a set of UAV attributes and location information associated with the UAV and a set of electric power line attributes relating to the electric power line. The operations may further include generating a charging output associated with the UAV and the electric power line, based on the classification label.

According to some example embodiments, the operations may further include receiving a set of labeled historic samples and determining a set of sample features relating to the set of labeled historic samples. The set of labeled historic samples may include positive samples and negative samples associated with one or more electric power lines. The operations may further include training a second machine learning model to label one or more unlabeled test samples with at least one of a positive label for presence of an electric power line or a negative label for absence of an electric power line, in the corresponding one or more unlabeled test samples, based on the set of labeled historic samples and the set of sample features.

According to some example embodiments, the operations may further include storing the trained first machine learning model, the trained second machine learning model along with the labeled training information and the labeled historic samples locally on the UAV.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the disclosure in general terms, reference will now be made to the accompanying drawings, which are not necessarily drawn to scale, and wherein:

FIG. 1 is a diagram that illustrates an environment of a system implemented for charging an unmanned aerial vehicle (UAV), in accordance with an example embodiment;

FIG. 2 illustrates a block diagram of a system for charging an UAV, in accordance with an example embodiment;

FIG. 3 illustrates a flowchart for implementation of an exemplary method for training a first machine learning model to assign classification labels, in accordance with an embodiment;

FIG. 4 illustrates a flowchart for implementation of an exemplary method for training a second machine learning model to detect electric power lines for charging, in accordance with an example embodiment;

FIG. 5 illustrates an example flowchart for implementation of an exemplary method to charge an UAV, in accordance with an example embodiment;

FIG. 6 illustrates an example flowchart for implementation of a method to charge an UAV, in accordance with an example embodiment;

FIG. 7 illustrates an example flowchart for implementation a method to charge an UAV, in accordance with an example embodiment; and

FIG. 8 illustrates an exemplary format of a database storing geographic data for charging predictions, in accordance with an example embodiment.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced item. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received and/or stored in accordance with embodiments of the present disclosure. Thus, use of any such terms should not be taken to limit the spirit and scope of embodiments of the present disclosure.

As defined herein, a “computer-readable storage medium,” which refers to a non-transitory physical storage medium (for example, volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

### Definitions

The term “unmanned aerial vehicle” may refer to an autonomous automotive vehicle that may use one or more electric motors for propulsion above ground surface, i.e., in air. In an example, the electric motors may be powered or propelled by electricity from extravehicular sources or a battery system. In an example, an UAV may use a traction battery pack to power the electric motor. For example, the battery pack may be plugged to a power outlet or a charging equipment, for charging. For example, the UAV may include charging port, battery pack, converters, one or more electric motors, charger, controller, cooling system, and transmission connects. In an example, the UAV may be a drone.

The term “electric power line” may refer to a power line used to transport electrical power from a generation unit or transmission unit to consumer. The electric power line may include one or more uninsulated electric cables for transporting power. For example, the electric power line may be suspended by towers or poles. In an example, the electric power line may transport power at a very high voltage and current level. The electric power line may be a part of a transmission network or a distribution network and may form electric grid for power delivery. For example, the electric power line may operate at a voltage of 240V, 415V, 1 lkV, 33 kV, 66 kV, 132 kV, and 220 kV.

The term “machine learning model” may refer to an engine or a set of engines that are configured to find patterns and make predictions or decisions, based on input data. For example, a machine learning (ML) model may include a vector of coefficients (data) that are multiplied and summed with a row of new data taken as input in order to make a prediction (prediction output). Examples of machine learning (ML) model may include, but are not limited to, linear regression models, classification models, deep neural networks, decision trees, random forests, and graphic models.

The term “route” may refer to a planned or a developed path that may be used by a vehicle to reach from one point to another point. The route may include, for example, roads, lanes, links, air space, and so forth.

The term “cargo” refers to all types of items and/or packaging suitable for delivery and may be known by other terms including but not limited to cargo, freight, payload, goods, package, parcel, box, bag, shrink-wrap, blister pack or some combination thereof.

### END OF DEFINITIONS

A system, a method, and a computer program product are provided herein in accordance with an example embodiment for charging an unmanned aerial vehicle (UAV). The system, the method, and the computer program product disclosed herein enables direct charging of an UAV from an electric power line, thereby substantially eliminating transmission and distribution losses and enabling rapid charging. Specifically, the system, the method, and the computer program product disclosed herein prevent overcrowding at charging stations, such as UAV charging station. Although the present disclosure describes techniques for charging an unmanned aerial vehicle, however, this should not be construed as a limitation. In other embodiments of the present disclosure, the techniques described in the present disclosure may be used for charging any other type of electric vehicle, such as electric cars, electric bike, electric scooter, and so forth.

The system, the method, and the computer program product disclosed herein may be configured to provide an alternative charging options for UAVs, such as directly from an electric power line. Subsequently, autonomous UAVs, for example, drones, and other electric vehicles, may land on or connect to electric power line for rapid and efficient charging while ensuring that operations of the vehicle is not interrupted. The system, the method, and the computer program product disclosed herein may be configured to identify, and provide alternative rapid charging solutions for UAVs, based on historical and real-time location and spatial intelligence information. For example, such alternative charging solution may be provided to the unmanned aerial vehicle, such as a user equipment on-board the unmanned aerial vehicle and a user associated with the unmanned aerial vehicle, through navigation instructions, notifications, in-app notifications, messages, prompts and so forth.

In an example, the system, the method, and the computer program product disclosed herein may be configured to identify and provide locations associated with recently used or nearby electric power lines for charging, and active or currently available power lines for charging. In addition, the computer program product disclosed herein may be configured to enable determination of one or more regions that may require installation of electric power lines for charging.

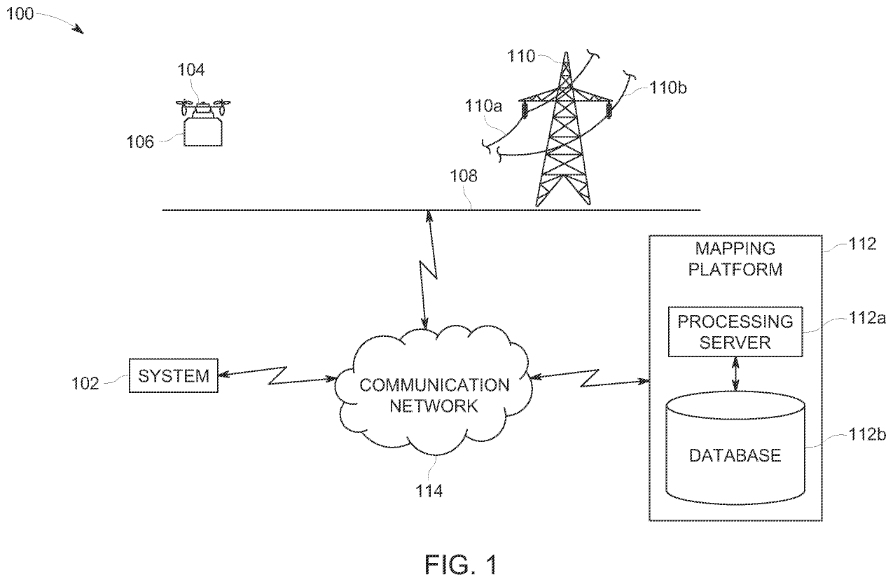

FIG. 1 is a diagram that illustrates an environment 100 of a system 102 implemented for charging an unmanned aerial vehicle (UAV) 104, according to one embodiment. In accordance with an example, the UAV 104 may be an aerial vehicle (e.g., aerial drones, or any other type of remotely operated autonomous vehicle). To this end, the use of an aerial vehicle may be widespread for commercial services, such as package delivery. For example, the UAV 104 may have to deliver a cargo. Use of the electric UAV 104 for delivery may provide economic benefits, convenience, and delivery of time-critical goods and services to difficult-to-reach places. Commercial delivery services generally require high number of successful trips (e.g., successfully reaching a delivery location or other destination with the cargo preserved for its intended use).

However, operational performance of an unmanned aerial vehicle, for example, drones, is limited. In particular, capacity of a battery of the UAVs may be limited owing to weight limitations. Subsequently, the UAVs may be able to operate for a limited time and within a limited range, depending on battery capacity and charge status. However, in certain cases a route to be travelled by the UAV may be long and may require more amount of power as compared to a current power capacity or current power charge of the battery. In such cases, the UAV may fail, i.e., fail to traverse the route due to battery discharge. In certain cases, the UAV may be configured to stop at a public charging station for re-charging. However, public charging stations may be overcrowded, and/or may have associated faults and losses. As a result, re-charging time may be prolonged and may affect delivery to be performed by the UAVs. Further, power discharge during an ongoing trip, such as an ongoing delivery, may affect the delivery time, a cargo associated with the delivery, and may cause loss of resource, such as loss of UAVs. Therefore, service providers may face significant technical challenges to optimize charging of unmanned aerial vehicles, such as UAVs, to ensure successful trip completion in light of suboptimal public charging infrastructure of electric vehicles.

Pursuant to embodiments of present disclosure, techniques for charging an unmanned aerial vehicle from an electric power line is disclosed. In particular, the unmanned aerial vehicle may have to land on the electric power line for changing. Once charged, the unmanned aerial vehicle may take off to complete its delivery, return to source, or perform any other operation. In this manner, operational time of the unmanned aerial vehicle may be enhanced. However, a charging outlet of an unmanned aerial vehicle may not be compatible with different types of electric power lines. In such cases, the unmanned aerial vehicle may fail to charge after landing. In certain cases, an electric power line may fail to support, such as, fail to bear a load of an unmanned aerial vehicle. In such cases, the landing of the unmanned aerial vehicle may potentially cause a fault at an electric power line, for example, when the electric power line is unable to bear the load of the unmanned aerial vehicle and may break causing an electrical fault. Such instances may affect power grid as well, which is highly undesirable. In addition, the unmanned aerial vehicle may incur certain cost, such as time, battery charge, etc., during a landing. However, in case of no charge, i.e., when the unmanned aerial vehicle fails to get charged after landing, the cost associated with the landing may be wasted. As a result, operational time and operational performance of the unmanned aerial vehicle may further decrease.

Although the various embodiments described herein are discussed with respect to unmanned aerial vehicle 104 operating in the airspace above the ground, it is contemplated that the embodiments are applicable to any type of electric vehicle (manned or unmanned, autonomous, or manually-controlled) including those operating on the surface of the Earth. For example, in an alternative embodiment, vehicles other than aerial vehicles, including but not limited to surface or ground vehicles (e.g., delivery robots, cars, trucks, trains, ships, etc.), can be used according to the various embodiments described herein. Throughout the present disclosure, the term “unmanned aerial vehicle” is used interchangeably with “drones”. This should not be construed as a limitation. Further, the term “electric power line” is used interchangeably with “power line”.

Generally, the unmanned aerial vehicle 104 may operate relative to (e.g., above, under, though, in, around, etc.) a ground 108, and/or across electric power lines. In one embodiment, the electric power lines may have been geo-referenced to become geo-referenced electric power lines, wherein the geo-referenced electric power lines may have one or more overhead cables related to corresponding geographic coordinates and/or corresponding land or ground space. For example, the geo-referenced electric power lines may be identified based on corresponding geographic coordinates (e.g., latitude and longitude) along with corresponding altitudes describing an airspace volume associated with the geographic coordinates. By way of example, the unmanned aerial vehicle 104 is tasked to deliver a cargo 106.

As shown in FIG. 1, the environment 100 may include the system 102, the unmanned aerial vehicle 104 carrying the cargo 106, an electric power line 110, and a mapping platform 112. The mapping platform 112 may further include a processing server 112a and a database 112b. In an example, the unmanned aerial vehicle 104 may include one or more sensors, a user equipment and/or a communication interface (not shown in the FIG. 1). Additional, fewer, or different components may be provided. For example, a proxy server, a name server, a map server, a cache server or cache network, a router, a switch or intelligent switch, a database, additional computers or workstations, administrative components, such as an administrative workstation, a gateway device, a backbone, ports, network connections, and network interfaces may be provided. While the components in FIG. 1 are shown as separate from one another, one or more of these components may be combined. In this regard, the system 102 may be communicatively coupled to the components shown in FIG. 1 to carry out the desired operations and wherever required modifications may be possible within the scope of the present disclosure.

To address the technical challenges, the system 102 of FIG. 1 introduces a capability to determine whether landing of the unmanned aerial vehicle 104 on the electric power line 110 for charging will be successful or not. In an example, the system 102 may obtain a set of electric power line attributes relating to the electric power line 110, specifically, electric cables 110a and 110b of the electric power line 110, that is built over a geographic and/or three-dimensional ground 108 area, and a set of UAV attributes relating to the unmanned aerial vehicle 104. The system 102 may then use the attributes to determine if the landing of the unmanned aerial vehicle 104 on the electric cables 110a or 110b of the electric power line 110 will be successful for charging or not. In one embodiment, the system 102 may also configure the unmanned aerial vehicle 104 to react in real-time and/or to re-route based on the mapped historical and real-time data and intelligence on charging to or from the electric power line 110. In this way, the system 102 may combine optimized vehicle routes with real-time edge decision making at critical decision points to ensure the success of a cargo delivery mission and enhanced operational time.

In one embodiment, to map the electric power line 110, the system 102 may incorporate a set of electric power line attributes, such as, but not limited to, the historical and real-time probe data (e.g., from other drones or other aerial vehicles), geographic data (e.g., geographic coordinates), sensor data, power ratings, cable state (such as, bowed or straight) and/or other available data associated with the electric power line 110 in a given geographic and/or three-dimensional region or area. For example, the system 102 may query data relating to electric power lines and images associated with each geographic and/or three-dimensional region having the electric power lines. In an example embodiment, the system 102 may query data associated with each geographic and/or three-dimensional region having selected electric power lines, wherein the selected electric power lines are configured to provide services for aerial vehicle charging.

Continuing further, the system 102 may combine the queried data relating to electric power lines for a particular geographic region with other environmental data associated with corresponding region and electric power line attributes associated with corresponding electric power lines. The environment data may include, but are not limited to, wind vector data, air traffic density data, rainfall data, visibility data, tidal current data, or some combination thereof. The electric power line attributes may include a type of charging service provided by the corresponding electric power lines, for example, power, time of availability for charging, time of unavailability for charging, successful charging operations, and so forth.

The system 102 may then generate geographic data indicating the geographic location, environment attributes and other attributes relating to electric power lines in a given geographic and/or three-dimensional region. The geographic data may represent the geo-referenced electric power lines. The geographic data may be stored in the database 112b. The geographic data in the database 112b can then be used to predict if charging of the unmanned aerial vehicle 104 on the electric power line 110 will be successful or unsuccessful. In this way, the system 102 advantageously enables operators of the unmanned aerial vehicle 104 to navigate their cargo 106 to longer distances with reduced risks arising from battery discharge of the aerial vehicle 104 on its route.

The images associated with each geographic and/or three-dimensional region having electric power lines may include images of, for example, satellite view of the region, terrain view of the region, map view of the region, real-world building point of interest structures in the region, road network in the region, electric power line in the region, cables associated with the electric power line, air space of the region, and/or other interior and exterior area plans corresponding to places where an unmanned aerial vehicle can move in the region. In an example, the images are pre-existing or publicly available images. For example, the images are originally formed or created for purposes other than generating a routable map. The pre-existing images may be generated by an entity separate from a developer of the charging infrastructure of unmanned aerial vehicle. The pre-existing images are available to the public or an entity for free or for a purchase price (e.g., online). Alternatively, self-generated images, images originally generated for creating a routable map, or non-public images may be used.

In some example embodiments, the system 102 may be coupled to a plurality of unmanned aerial vehicles. In an example, the system 102 may be coupled to the unmanned aerial vehicle 104, via a communication interface and a network 114. In an embodiment, the system 102 may be coupled to one or more communication interfaces, for example, as a part of a routing system, a navigation app on-board the unmanned aerial vehicle 104, and the like. In some example embodiments, a user equipment is associated, coupled, or otherwise integrated with the unmanned aerial vehicle 104 as, for example, an advanced driver assistance system (ADAS), a personal navigation device (PND), a portable navigation device, an infotainment system and/or other device that may be configured to provide route guidance and navigation related functions to the unmanned aerial vehicle 104. In an example, the user equipment may include one or more sensors, a processor, a memory, and the communication interface. The processor, the sensors, the memory, and the communication interface may be communicatively coupled to each other.

In some example embodiments, the unmanned aerial vehicle 104 may include processing means such as a central processing unit (CPU), storage means such as on-board read only memory (ROM) and random access memory (RAM), acoustic sensors such as a microphone array, position sensors such as a GPS sensor, gyroscope, a LIDAR sensor, a proximity sensor, motion sensors such as accelerometer, an image sensor such as camera, a display enabled user interface such as a touch screen display, arms for carrying the cargo 106, and other components as may be required for specific functionalities of the unmanned aerial vehicle 104.

In one embodiment, the unmanned aerial vehicle 104 and the mapping platform 112 may be directly coupled to the system 102 via the network 114. In another embodiment, the unmanned aerial vehicle 104 may be coupled to the system 102 via an OEM (Original Equipment Manufacturer) cloud and the network 114. For example, the unmanned aerial vehicle 104 may be consumer vehicle and may be a beneficiary of the services provided by the system 102. In some example embodiments, the unmanned aerial vehicle 104 may serve the dual purpose of data gatherers and beneficiary devices.

In an example embodiment, the system 102 may be onboard the unmanned aerial vehicle 104, such as the system 102 may be a charging system installed in the unmanned aerial vehicle 104 for finding electric power lines or source and initiating landing process for charging and providing navigation instructions to reach the charging station or source. In an example, the unmanned aerial vehicle 104 may be an autonomous vehicle, a semiautonomous vehicle, or a remotely-manually operated vehicle. In another example embodiment, the system 102 may be the processing server 112a of the mapping platform 112, and therefore may be co-located with or within the mapping platform 112. For example, the system 102 may be embodied as a cloud based service, a cloud based application, a cloud based platform, a remote server based service, a remote server based application, a remote server based platform, or a virtual computing system. In yet another example embodiment, the system 102 may be an OEM (Original Equipment Manufacturer) cloud. The OEM cloud may be configured to anonymize any data received by the system 102, such as from the user equipment or the unmanned aerial vehicle 104, before using the data for further processing, such as before sending the data to database 112b. In an example, anonymization of the data may be done by the mapping platform 112.

The system 102 may be communicatively coupled to the unmanned aerial vehicle 104, and the mapping platform 112, via the network 114. In an embodiment, the system 102 may be communicatively coupled to other components, for example, user equipment, and so forth, not shown on FIG. 1 via the network 114. The network 114 may be wired, wireless, or any combination of wired and wireless communication networks, such as cellular, Wi-Fi, internet, local area networks, or the like. In some embodiments, the network 114 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

All the components in the environment 100 may be coupled directly or indirectly to the network 114. The components described in the environment 100 may be further broken down into more than one component and/or combined together in any suitable arrangement. Further, one or more components may be rearranged, changed, added, and/or removed.

The mapping platform 112 may comprise suitable logic, circuitry, and interfaces that may be configured to store geographic data indicating one or more geographic attributes associated with geographic regions including electric power lines, such as the electric power line 110. The mapping platform 112 may also be configured to store map data indicating one or more location information associated with the unmanned aerial vehicle 104. The mapping platform 112 may be further configured to store and update data indicating power line attributes associated with the electric power line 110 and UAV attributes associated with the unmanned aerial vehicle 104, in the database 112b. The mapping platform 112 may include techniques related to, but not limited to, geocoding, routing (multimodal, intermodal, and unimodal), clustering algorithms, machine learning in location based solutions, natural language processing algorithms, and artificial intelligence algorithms. Data for different modules of the mapping platform 112 may be collected using a plurality of technologies including, but not limited to drones, sensors, connected cars, cameras, probes, and chipsets. In some embodiments, the mapping platform 112 may be embodied as a chip or chip set. In other words, the mapping platform 112 may comprise one or more physical packages (such as, chips) that includes materials, components and/or wires on a structural assembly (such as, a baseboard).

In some example embodiments, the mapping platform 112 may include the processing server 112a for carrying out the processing functions associated with the mapping platform 112 and the database 112b for storing geographic data and other attributes. In an embodiment, the processing server 112a may comprise one or more processors configured to process requests received from the system 102. The processors may fetch attributes and/or geographic data from the database 112b and transmit the same to the system 102 in a format suitable for use by the system 102. In some example embodiments, as disclosed in conjunction with the various embodiments disclosed herein, the system 102 may be used to process the attributes and the geographic data for determining the electric power line 110 for charging the unmanned aerial vehicle 104 and generating navigation instructions using the attributes corresponding to the electric power line 110, the unmanned aerial vehicle 104 and map data.

Continuing further, the database 112b may comprise suitable logic, circuitry, and interfaces that may be configured to store the attributes relating to the unmanned aerial vehicle 104 (referred to as a set of UAV attributes, hereinafter), attributes relating to the electric power line 110 (referred to as a set of electric power line attributes, hereinafter), geographic data, and map data. Such data may be collected from a database associated with the unmanned aerial vehicle 104, the unmanned aerial vehicle 104 itself, a database associated with the electric power line 110, unmanned aerial vehicles travelling across a region associated with the electric power line 110, unmanned aerial vehicles that used the electric power line 110 for charging, and so forth. In an example, the mapping platform 112 may receive the data and fuse the data to infer electric power line-related information and unmanned aerial vehicle 104 information for charging. The data may be collected from any sensor that may inform the mapping platform 112 or the database 112b of features within an environment of the geographic region having the electric power line 110 and/or the unmanned aerial vehicle 104 that are appropriate for charging and routing related services or mapping services. For example, motion sensors, inertia sensors, image capture sensors, proximity sensors, LIDAR (light detection and ranging) sensors, and ultrasonic sensors may be used to collect the data.

In accordance with an embodiment, the database 112b may be configured to receive, store, and transmit the data that may be collected from vehicles travelling throughout one or more geographic regions having one or more electric power lines. In accordance with another embodiment, a developer may employ field personnel to travel by a vehicle, such as an aerial vehicle along one or more geographic regions to observe features and/or record information, such as the power line attributes, and map data. The map developers may crowd source geographic map data (or the map data) and the set of electric power line attributes to accurately determine success rate for landing on a power line for charging.

In some example embodiments, the database 112b may also be configured to receive, store, and transmit other sensor data and probe data including positional, speed, and temporal data received from the vehicles, such as aerial vehicles. The probe data may be used to determine traffic volume, such as air traffic volume, associated with movement of vehicles on or around one or more electric power lines. The traffic volume associated with the one or more electric power lines may correspond to the vehicles on each of the one or more power lines for a given time period for charging. The probe count from the probe data may be observed within the given time period and projected to determine the traffic volume for that given time period. In accordance with an embodiment, the probe data may include, but are not limited to, real time speed (or individual probe speed), incident data, geolocation data, timestamp data, and historical pattern data.

The database 112b may further be configured to store the traffic-related data and topology and geometry-related data for a route network, road network, and/or an air space routes, as map data. The map data may also include cartographic data, routing data, and maneuvering data. In accordance with an embodiment, the database 112b may be configured to receive the vehicle attributes, the power line attributes, the geographic data relating to power lines, map data, and the topology and geometry-related attributes from external systems, such as, one or more of background batch data services, streaming data services, and third party service providers, via the network 114.

In some embodiments, the database 112b may further store historical charging data for successful and unsuccessful charging from one or more electric power lines or other records of the database 112b.

For example, the data stored in the database 112b may be compiled (such as into a platform specification format (PSF)) to organize and/or processed for identifying charging operation cost, charging operation success or fail and generate or update navigation-related functions and/or services, such as route calculation, route guidance, speed calculation, distance and travel time functions, navigation instruction generation, and other functions, by a navigation device, such as a UE. The navigation-related functions may correspond to navigation to a favored charging source, navigation to a closest charging source, re-routing of a route of delivery, and other types of navigation. While example embodiments described herein generally relate to aerial vehicular travel, example embodiments may be implemented for other electric vehicles. The compilation to produce the end user databases may be performed by a party or entity separate from the map developer. For example, a customer of the map developer, such as a navigation device developer or other end user device developer, may perform compilation on a received database 112b in a delivery format to produce one or more compiled navigation databases.

In some embodiments, the database 112b may be a master database configured on the side of the system 102. In accordance with an embodiment, a client-side map database may represent a compiled navigation database that may be used in or with end user devices (e.g., user equipment associated with the unmanned aerial vehicle 104) to determine electric power line 110 for successful charging and provide navigation instructions, and/or map-related functions to navigate through to the electric power line 110.

The system 102 may comprise suitable logic, circuitry, and interfaces that may be configured to detect electric power line 110 for charging an unmanned aerial vehicle 104 and/or updating navigation instructions for routing the unmanned aerial vehicle 104 to the electric power line 110.

In operation, the system 102 may be configured to obtain a set of UAV attributes and location information associated with the unmanned aerial vehicle 104. In an example, the set of UAV attributes may include, but are not limited to, size or dimensions of the unmanned aerial vehicle 104, weight of the unmanned aerial vehicle 104, weight of the cargo 106 carried by the unmanned aerial vehicle 104, current battery charge status or remaining battery charge of the unmanned aerial vehicle 104, charging adaptor properties of the battery of the unmanned aerial vehicle 104, or a combination thereof.

Thereafter, the system 102 may be configured to identify a plurality of electric power lines in proximity of the unmanned aerial vehicle 104, based on the location information. In particular, the system 102 may determine a geographic region corresponding to the unmanned aerial vehicle 104 based on the location information, i.e., a geographic region within which the unmanned aerial vehicle 104 is currently operating. Based on a mapping between the geographic region of the unmanned aerial vehicle 104 and geographic regions corresponding to different electric power lines, the system 102 may determine one or more electric power lines within the geographic region of the unmanned aerial vehicle 104 or in proximity to the unmanned aerial vehicle 104. Pursuant to present example, the system 102 may determine electric power line 110 to be in proximity to the unmanned aerial vehicle 104.

Further, the system 102 may be configured to obtain a set of electric power line attributes relating to the plurality of identified electric power lines. In an example, the set of electric power line attributes may include attributes relating to the electric power line 110. In an example, the set of electric power line attributes may include, but are not limited to, geographic data associated with the corresponding electric power lines, power rating (such as voltage level), type of cables 110a and 110b (such as, straight or bowed), or a combination thereof.

Thereafter, the system 102 may be configured to identify one or more electric power lines from the plurality of electric power lines based on the set of UAV attributes, the set of electric power line attributes and a trained first machine learning model. In this regard, the system 102 may determine a classification label for charging of the unmanned aerial vehicle 104 by the one or more electric power lines from the plurality of electric power lines, such as the electric power line 110. The classification label may be determined using the set of UAV attributes, the set of electric power line attributes. In accordance with an embodiment, the system 102 may have a capability to use machine learning (e.g., Bayes Net, Random Forest, Decision Trees, etc.) with the constructed set of UAV attributes, the set of electric power line attributes to train the first machine learning model to learn how to assign correct classification label to an unlabeled landing operation of the unmanned aerial vehicle 104 on the electric power line 110 (e.g., an unlabeled power line with no assigned classification label for charging in the database 112b). In one embodiment, the trained first machine learning model receives values of the set of UAV attributes and the set of electric power line attributes as an input, and then outputs a classification label for landing of the unmanned aerial vehicle 104 on the electric power line 110. For example, the classification label may indicate at least one of a successful charging or an unsuccessful charging, based on the training of the trained first machine learning model.

In an example embodiment, the system 102 may be configured to identify or detect the electric power line 110 within a region of interest or region corresponding to location of the unmanned aerial vehicle 104, using a second machine learning model. In an example, the region of interest may correspond to a region nearby or below (i.e., on ground level) a route on which the unmanned aerial vehicle 104 is travelling. Subsequently, electric power line within regions of interest may involve substantially less re-routing of the unmanned aerial vehicle 104 to ensure minimum cost associated with the re-routing and charging. In particular, the second machine learning model may detect the electrical power line by processing one or more images captured by the unmanned aerial vehicle 104 of the corresponding route, stock images of the route, or by querying database 112 for geographic data corresponding to the region of interest.

Continuing further, the system 102 may be configured to direct the unmanned aerial vehicle 104 to the identified one or more electric power lines for charging the unmanned aerial vehicle 104, In this regard, the system 102 may generate a charging output associated with the unmanned aerial vehicle 104 and the electric power line 110, based on the classification label. In an example, under a successful classification label, the charging output may include when and where to charge the unmanned aerial vehicle 104 on the electric power line 110. For example, the charging output may include which of the cables 110 and 110b to land on and a time of landing and take-off. However, under an unsuccessful classification label, the charging output may include abort charging of the unmanned aerial vehicle 104 from the electric power line 110. In such case, the system 102 may then search for another electric power line for charging the unmanned aerial vehicle 104. In this manner, the system 102 may direct the unmanned aerial vehicle 104 to land on the electric power line 110 for charging.

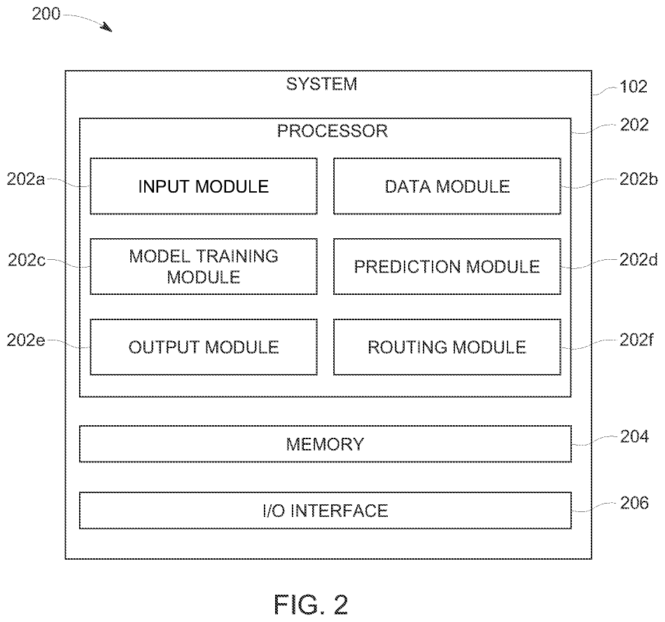

FIG. 2 illustrates a block diagram 200 of the system 102, exemplarily illustrated in FIG. 1 that may be used for charging an unmanned aerial vehicle (UAV), in accordance with an example embodiment. FIG. 2 is explained in conjunction with FIG. 1.

The system 102 may include at least one processor 202, a memory 204, and an I/O interface 206. The at least one processor 202 may comprise modules, depicted as an input module 202a, a data module 202b, a model training module 202c, a prediction module 202d, an output module 202e and a routing module 202f

In accordance with an embodiment, the system 102 may store data that be generated by the modules while performing corresponding operation or may be retrieved from a database associated with the system 102. In an example, the data may include map data, probe data, geographic data, UAV attributes, location information, power line attributes, sensor data, training data, charging output, and navigation or routing instructions.

In an example embodiment, the data module 202b may determine a plurality of features that are to be used for training a machine learning model to assign classification labels. For example, the data module may also identify classification labels, using labeled data for training. In an example, the plurality of features may include, but are not limited to, vehicle-related features per epoch, power line-related features per epoch, environment-related features per epoch, tuples of aforementioned features. Such plurality of features may form functional class features of electric power lines and UAVs. In one embodiment, to determine which features are to be used, i.e., to determine the functional class features, the data module 202b may evaluate whether values for each candidate feature is sufficiently different (e.g., statistically significant, different beyond a threshold) for each corresponding classification label. In an example, the classification label may be one of successful label for successful charging and unsuccessful label for unsuccessful or failed charging.

Further, the data module 202b collects and/or analyzes data from the database 112b, and/or any other data repositories available over the network 114 to obtain values for the plurality of features corresponding to the functional class features. For example, the data module 202b may query the database 112b for functional class values for electric power lines of interest. In addition, the data module 202b may collect and/or analyze probe or trajectory data as stored in the database 112 and/or generated by one or more UAVs or UE on-board the UAVs. For example, the data module 203 determines probe traces from the probe data that originate from or terminate at electric power lines of interest. The probe traces are then used to compute traffic related features such as the historical traffic, availability for charging, and charging service based on time of day and week related features.

In one embodiment, the data module 202b assembles a set of training data based on the functional class features and corresponding functional or feature class values. The training data, for instance, comprises power line-related features and UAV-related features that have been assigned or labeled with classification labels that are used as ground truth data for training. The data module 202b then retrieves or otherwise computes the values for the power line-related features and UAV-related features and incorporates those values into the training data. In an example, the training data may also include values associated with environment—related features For example, the training data may include data records specifying a ground truth classification label for landing of one or more UAVs on one or more electric power lines, and the determined feature values for the landing, the one or more UAVs, the one or more electric power line and environment as fields of the data record. In one embodiment, the training data can be divided into a training set for actually training machine learning model(s), and a test/validation set for validating or determining an accuracy of the trained machine learning model.

In one embodiment, the model training module 202c uses the training data (e.g., to initiate a training of a machine learning model to assign classification labels to unlabeled test landing). In one embodiment, depending on a type of machine learning model that is used (e.g., Bayes Net, Decision Tree, etc.), the model training module 202c may initiate a tuning of hyper-parameters for the machine learning model before training of the model is performed. By way of example, a hyperparameter is a parameter of the machine learning model that affects how machine learning algorithm trains itself (e.g., parameters related to avoiding overfitting of data by the model). Generally, hyperparameters cannot be learned directly from the training data in the standard model training process and need to be predefined. Examples of hyperparameters are regularization parameters such as a “C” parameter that determines the margin of separation for a classification hyperplane. For example, the “C” or regularization parameter can be varied to avoid misclassifying each training sample. Other examples of hyperparameters include, but are not limited to, a training window duration, a number of leaves or depth of a tree, a learning rate, etc.

The model training module 202c may then initiate the training of a machine learning model, such as a first machine learning model by feeding the known classification labels and functional class values of the training data into the machine learning model. In one embodiment, the model training module 202c may train a number of different machine learning models (e.g., Bayes Net, Decision Trees, Support Vector Machines, Neural Networks, etc.) with the training data. The model training module 202c may then evaluate accuracy or other performance characteristics (e.g., true positive rates, false positive rates, specificity, etc.) to select a model to use as the first machine learning model for assigning classification labels to unlabeled test landing.

Once trained, the trained first machine learning model may be configured to predict classification labels for unlabeled test landing of an unmanned aerial vehicle, such as the UAV 104 on an electric power line, such as the electric power line 110. In accordance with an embodiment, the input module 202a may obtain a set of features relating to the unlabeled landing. In particular, the input module 202a may retrieve a set of features relating to the UAV 104 and the electric power line 110. For example, the input module 202a may access the database 112b and/or other databases associated with the system 102, the UAV 104 and the electric power line 110, to obtain the set of features. The set of features may include, for example, a set of UAV attributes and location information relating to the UAV 104 and a set of electric power line attributes relating to the electric power line 110. For example, the set of features may also include a set of environment attributes relating to real-time and/or historical environment associated with the electric power line 110, i.e., geographical region associated with the electric power line 110.

In one embodiment, the prediction module 202d may then use the trained first machine learning model to assign classification labels to unlabeled landings. For example, to label a charging with a classification label, the prediction module 202d may interact with the data module 202b to determine respective values for the set of features (e.g., functional class values, historical charging output, etc.). The values for the set of feature may then be fed into the machine learning model to output classification label for the charging of the UAV 104 by the electric power line 110 at a particular time. The prediction module 202d may then store the assigned classification label as landing data for the particular landing for charging. For example, the data record corresponding to charging from the electric power line 110 for the UAV 104 in question may be updated to specify the assigned classification label.

In one embodiment, the prediction module 202d may assign classification labels to charging to be performed by landing the UAV 104 on plurality of electric power lines. In an example, a landing of the UAV 104 on electric power lines for charging may be specified or input by a user or an administrator. For example, the user may provide a list of electric power lines where the UAV 104 may land for charging in one or more regions, wherein different landings on different electric power lines are to be labeled by the prediction module 202d. In another example, the prediction module 202d may identify a plurality of electric power lines in proximity of the UAV 104, based on the location information associated with the UAV 104. In such case, the UAV 104 may land on one or more electric power lines from the plurality of electric power lines for charging. Subsequently, the landing on the plurality of electric power lines may be assessed and corresponding classification label may be predicted by the prediction module 202d. For example, the prediction module 202d may initiate the labeling the landing with classification label for charging in corresponding landing, wherein landing may be done on electric power lines on the list or the plurality of electric power lines in proximity.

The prediction module 202d may identify one or more electric power lines from the plurality of electric power lines based on the set of UAV attributes, the set of electric power line attributes and the trained first machine learning model. In particular, the prediction module 207 may automatically identify or determine which electric power line(s) to land on for successful charging. Such identified electric power line(s) may have successful classification label corresponding to it, indicating that charging of the UAV 104 would be successful by landing on the identified electric power line(s).

In an example embodiment, the prediction module 202d may be triggered for autonomous or automatic determination of the plurality of electric For example, such autonomous determination may be determined based on current charge level of battery of the UAV 104 (such as, when charge in the battery is low), identification of a region or location where electric power line of interest may exist, and/or detection of the electric power line of interest. These landings may then be automatically labeled with classification labels according to the various embodiments described herein.

In one embodiment, the output module 202e may then generate instructions to direct the UAV 104 to the identified one or more electric power lines for charging the UAV 104. In an example, the prediction module 202d may determine that landing of the UAV 104 on the one or more electric power lines may result in successful charging. For example, the output module 202e may determine an electric power line, such as the electric power line 110, from the identified one or more power lines having successful classification label for landing. In an example, the electric power line for landing may be the electric power line 110 that is nearest to an original route of the UAV 104. Subsequently, the output module 202e may generate navigation instructions or trigger a navigation system on-board the UAV 104 to navigate the UAV 104 to the electric power line 110 for charging.

In an example, the output module may generate a charging output associated with the landing of UAV 104 on the electric power line 110, based on the classification label. For example, the classification label may indicate if charging of the UAV 104 on the electric power line 110 will be successful or not, i.e., whether the UAV 104 will be able to charge from the electric power line 110 or not. Further, the output modules 202e may provide the charging output to the UAV 104 and/or a user associated with the UAV 104. For example, the charging output and the classification label may be provided to the user and/or the UAV 104, via a user interface. The user interface may also provide options for the user to review and/or approve the automatically generated classification label and charging output.

In an example embodiment, the output module 202e may present information relating to when and where the UAV 104 may land on the electric power line 110 successfully, i.e., for successful charging. In an example embodiment, the charging output may include a time and a spot on the electric power line 110 for landing the UAV 104 on the electric power line 110.

In certain cases, a voltage carried by the electric power line 110 may be different from a voltage rating of battery input of the UAV 104. In such a case, a step-up or a step-down transformer may be utilized by the UAV 104 for charging. In this regard, the charging output may include a trigger for activating one of the step-up transformer or the step-down transformer for syncing voltage rating of electric output of the electric power line 110 with the voltage rating of the battery input of the UAV 104.

Thereafter, based on the charging output, the UAV 104 may land on the electric power line 110 for charging. In one example, the UAV 104 may form a closed path between an electric cable (such as, a phase line) of the electric power line and neutral line of the electric power line. Based on contact between the UAV 104 and the phase and neutral line of the electric power line 110, electric power or charges may get transferred from the electric power line 110 to battery of the UAV 104. In another example, the UAV 104 may get charged by the electric power line 110 inductively and without forming a physical contact. In this regard, the UAV 104 may not physically land on the electric power line 110 but is positioned in close proximity to the electric power line 110, or a phase line of the electric power line 110, so that inductive flow of charges may occur. In one embodiment, the output module 202e may provide the generated classification label, navigation instructions and charging output to support the UAV 104 in finding the electric power line 110 of interest for charging or route planning. For example, the output module 202e may initiate a presentation of an end user interface at the UAV 104 and/or UE, wherein the end user interface depicts representations (e.g., visual representation, audio representation, etc.) of the electric power line 110 for charging of the UAV 104. It is further noted that the output 202e may operate over the communication network 114 to facilitate the exchange of classification label, navigation instructions and charging output.

The above presented modules and components of the system 102 can be implemented in hardware, firmware, software, or a combination thereof. Though depicted as a separate entity in FIG. 1, it is contemplated that the system 102 may be implemented as a module of any of the components of the mapping platform 112. In another embodiment, one or more of the modules 202a-202f may be implemented as a cloud based service, local service, native application, or combination thereof.

In accordance with an embodiment, the output module 202e may also store the determined charging output corresponding to the landing of the UAV 104 on the electric power line 110 along with corresponding processed information. In an example, the processed information and the charging output may then be fed to the routing module 202f. The routing module 202f may be configured to generate user readable or user-understandable navigation instructions, such as routing messages, notifications, etc., based on the charging output. The routing module 202f may send or push the routing messages to user equipment, such as the user equipment on-board the UAV 104, to enable routing of the UAV 104 towards the electric power line.

The processor 202 may retrieve computer executable instructions that may be stored in the memory 204 for execution of the computer executable instructions. The memory 204 may store the training data, and/or obtained functional class values of set of features associated with the UAV 104 and the electric power line 110. In accordance with an embodiment, the processor 202 may be configured to retrieve input (such as, real-time sensor data, historical probe data, real-time probe data, map data indicating map attributes associated with route of UAV 104, geographic data indicating geographic coordinates associated with the UAV 104 and the electric power line, and historical charging output data) from background batch data services, streaming data services or third party service providers, and renders output, such as, the charging output, the classification label, navigation instructions, and notification associated with the landing for use by the end user through the I/O interface 206.

The processor 202 of the system 102 may be configured to identify a plurality of electric power lines in proximity of the UAV 104, based on the location information associated with the UAV 104. The processor 202 may be further configured to determine classification label for charging of the UAV 104 by landing on the plurality of electric power lines, based on the set of UAV attributes associated with the UAV 104, a set of electric power line attributes associated with the plurality of electric power lines and using the trained first machine learning model. Based on the classification label, the processor 202 may identify one or more electric power lines from the plurality of electric power lines that may have successful charging classification label, i.e., that may be used for charging the UAV 104. The processor 202 may determine charging output for landing for charging. The processor 202 may be further configured to update map data and set of features corresponding to the landing of the UAV 104 on the electric power line 110 for charging and generate navigation instructions for directing the UAV 104 to the electric power line 110.

The memory 204 of the system 102 may be configured to store a dataset (such as, but not limited to, the training data, the set of features including the set of UAV attributes, location information and the set of electric power line attributes, the functional class values associated with the set of features, the geographic data, the probe data, and the map data) associated with the landings on electric power lines. In accordance with an embodiment, the memory 204 may include processing instructions for processing the set of features. The dataset may include real-time data and historical data, from service providers.

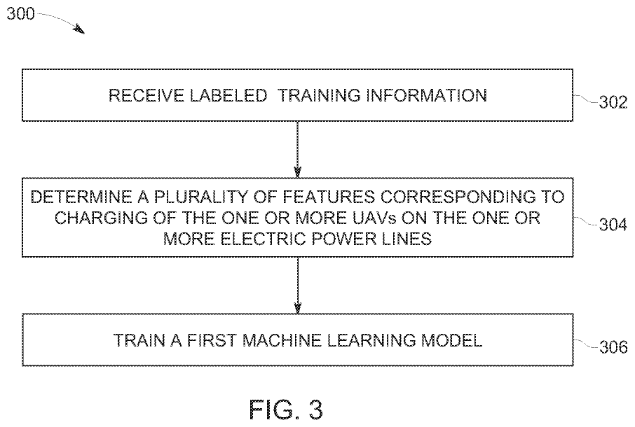

FIG. 3 illustrates a flowchart for implementation of an exemplary method 300 for training a first machine learning model to assign classification labels, in accordance with an example embodiment. In various embodiments, the mapping platform 112 or the system 102 may perform one or more portions of the method 300 and may be implemented in, for instance, a chip set including a processor and a memory. As such, the mapping platform 112 or the system 102 may provide means for accomplishing various parts of the method 300, as well as means for accomplishing embodiments of other processes described herein in conjunction with other components of the system 102. Although the method 300 is illustrated and described as a sequence of steps, its contemplated that various embodiments of the method 300 may be performed in any order or combination and need not include all of the illustrated steps.

At 302, labeled training information relating to charging of one or more UAVs on one or more electric power lines is received. For example, the data module 202b may retrieve the labeled training information from the database 112b and/or other databases associated with the system 102. The labeled training information (also referred to as labeled training data) may include a set of UAV attributes relating to the one or more UAVs, a set of power line attributes relating to the one or more electric power lines, and a set of labels indicating a classification of charging. In an example, the set of labels may include successful charging and unsuccessful charging.

For example, the labeled training information is historical and consists of tuples of the features associated with landing, such as power line attributes, UAV attributes, and environment attributes. The labeled training information also include a set of labels indicating ground truth labels which denotes a successful or unsuccessful landing based on attributes or features of historical landings and subsequent charging.

In accordance with an embodiment, the labeled training data may include data pertaining to several historic landing samples of one or more UAVs on one or more electric power lines. In accordance with an example, the training data may be generated by the data module 220b by identifying functional class features associated with assigning classification labels, and collating values or functional class values pertaining to the historic landing samples.

At 304, a plurality of features corresponding to charging of the one or more UAVs on the one or more electric power lines is determined, using the labeled training information. In an example, the data module 202b may determine the plurality of features, based on functional class values that may be selected to train the first machine learning model.

In one embodiment, the plurality of features used to train the first machine learning (ML) model for assigning classification label includes, but is not limited to, functional class features of the UAVs, the electric power lines, and environment. By way of example, the functional class features is a grouping of features of electric power lines by the role of the charging service for charging the UAVs. In an example, functional class features relating to electric power lines for assigning classification label may include, but are not limited to, power rating of electric power lines, a speed of charging, capacity of the electric power lines, design (e.g. straight or bowed cables), number of phases (e.g., single phase or three-phase), total number of cables (e.g., double circuits, single circuit, etc.), relationship to other electric power lines, other wires associated with electric power lines (e.g., neutral line and telephone wires running along phase conductors of the electric power lines), active or charging service time of electric power lines, downtime of electric power lines, fault status of electric power lines, and geographic features (e.g., coordinates, region, etc.). It may be noted that straight electric wire or cable refers to overhead cables that are pulled tightly from both its ends, i.e., high tension, such that the cable is horizontally aligned. On the other hand, the bowed electric wire or cable refers to overhead cables that are not tightly held thereby causing sagging of the cable. The bowed wire or cable may not have high tension.

Further, examples of functional class features relating to an UAV may include, but are not limited to, principal routes (e.g., flight paths for primary operations or original route, such as route of delivery operations, etc.), size and weight of the UAV, cargo information associated with the UAV, battery properties (e.g., age of battery, type of battery, capacity of battery, etc.) of the UAV, and charging adaptor properties of the UAV. Further, the functional class features may also relate to environment at a time of landing in the historic labeled landing sample such as, but are not limited to, visibility, wind speed, rain, air traffic density, etc.

In one embodiment, each functional class feature is identified according to a number (e.g., 1=power rating of electric power lines, 2=design, 3=phase, and 4=principal or original route). In an example, the number to the functional class features may be assigned in accordance with decreasing importance of the corresponding functional class features in determining classification label for charging UAVs. It may be noted that values corresponding to the functional class features may form the function class values to be used for training. To this end, the functional class features are selected features that are identified for training and the first training model is then trained based on the functional class features and values of the functional class features. For example, the first machine learning model may determine a relationship between functional class features and functional class values to apply, after training on ground truth data. For example, the set of labels associated with the labeled landing samples in the training data may include the ground truth labels (or the ground truth data) indicating at least one of a successful charging or an unsuccessful charging. Based on the relationship, the first ML model may learn relationship between functional class features and corresponding functional values for successful charging and unsuccessful charging.

At 306, the first machine learning model is trained to label one or more unlabeled test information with a classification label indicating classification of charging, using the set of features and the set of labels. In an example, the model training module 202c of the system 102 may be configured to train the first ML model based on the labeled training information generated by the data module 202b. The labeled training information may include the labeled historic landing samples, the set of labels, functional class features and functional class values. In an example, the first ML model may be trained to identify relationships between functional class features and functional class values for different classification labels, i.e., for successful charging label and unsuccessful charging label, in the labeled historic landing samples. Such identification of relationship and patterns may be done based on corresponding classification labels, the functional class features, and the functional class values. Based on the relationship, the first ML model may learn to assign classification label to unlabeled test information. The unlabeled test information may include features relating to unlabeled landing samples. Once trained on the labeled training information, the first ML model may be configured to classify the unlabeled landing samples in the unlabeled test information. To this end, the first ML model may be a neural network machine learning model, for example, artificial neural network (ANN), support vector model (SVM), convolution neural network (CNN), and so forth. For example, the trained first ML model along with corresponding training data, i.e., the labeled historic samples, may be stored locally on an UAV, or may be stored remotely (for example, on a cloud or other remote platform).

In an example, the trained first machine learning model along with the labeled training information and unlabeled test information are stored locally on the UAV 104, or on a cloud remotely.

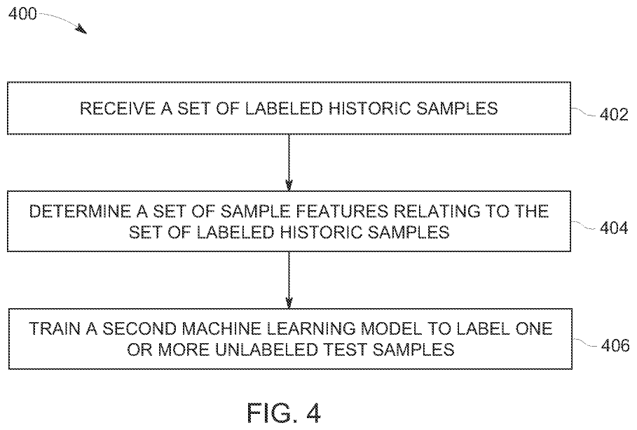

FIG. 4 is a flowchart for implementation of an exemplary method 400 for training a second machine learning model to detect electric power lines for charging, according to one embodiment. In various embodiments, the mapping platform 112 or the system 102 may perform one or more portions of the method 400 and may be implemented in, for instance, a chip set including a processor and a memory. As such, the mapping platform 112 or the system 102 may provide means for accomplishing various parts of the method 400, as well as means for accomplishing embodiments of other processes described herein in conjunction with other components of the system 102. Although the method 400 is illustrated and described as a sequence of steps, its contemplated that various embodiments of the method 400 may be performed in any order or combination and need not include all of the illustrated steps.

At 402, a set of labeled historic samples associated with one or more electric power lines is received. In an example, the set of labeled historic samples may include a plurality of historic images associated with one or more electric power lines that are labeled as one of positive sample and negative sample. Subsequently, the set of labeled historic samples may include positive samples and negative samples associated with one or more electric power lines. In an example, the system 102, specifically, the data module 202b may gather the set of labeled historic samples as training data. For an UAV to detect an electric power line effectively, the second machine learning may have to be trained with historical samples or historical images having electric power lines representing positive samples and historical samples or historical images not having electric power lines representing negative samples.

At 404, a set of sample features relating to the set of labeled historic samples are determined. In an example, the data module 202b of the system 102 may identify functional class features that may have to be used for training. Such functional class features may include the set of sample features. For example, the data module 202b may then retrieve functional class values or values of the set of sample features associated with the historic samples. Based on the functional class features and the functional class values, the second machine learning model may have to be trained.

Examples of the functional class features corresponding to the historic samples may include, but are not limited to, numerical data (such as, array information) corresponding to several pixels, edged, sides, corners, and other areas, color histograms, object, or shape features and/or other image features relating to image processing and classification. For example, the functional class values may have numerical values. Such numerical functional class values may be provided as input to the second machine learning model.

At 406, the second machine learning model is trained to label one or more unlabeled test samples associated with the one or more electric power lines. In an example, the model training module 202c of the system 102 may be configured to train the second machine learning model based on the training data generated by the data module 202b. The training data may include the labeled historic samples and the set of sample features or functional class features and functional class values. In an example, the second ML model may be trained to identify patterns in the labeled historic samples based on corresponding positive and negative label, the functional class features, and the functional class values. Based on the learning, weights associated with the second ML model may be updated. Based on the identification and weights, the second ML model may learn to assign label to unlabeled test sample. To this end, the second machine learning model may be a neural network machine learning model, for example, artificial neural network (ANN), support vector model (SVM), convolution neural network (CNN), and so forth. For example, the trained second machine learning model along with corresponding training data, i.e., the historic samples, may be stored locally on the UAV 104, or may be stored remotely (for example, on a cloud or other remote platform).

In an example, the historic samples may include historic images of various regions. Such historic samples may include (1) positive samples that may include images having electric power line within them, and (2) negative samples that may include images not having electric power line within them. For example, the negative samples may include images of wires or cables other that electric power lines, such as telephone wires, cable television wires, internet connection wires, and other objects, such as trees, buildings, antennas, insulated power lines that may not be capable of charging. To this end, the functional class features of the historic samples may be identified. The sample features or functional class features may be based on pixels of historic samples. Thereafter, the second ML model may be trained to distinguish electric power line that may be used for charging from other objects, such as the telephone wires, the cable television wires, the internet connection wires, trees, buildings, antennas, etc. For example, the trained second ML model may perform labeling of images as a positive sample for presence of an electric power line or a negative sample for absence of electric power line in real-time.

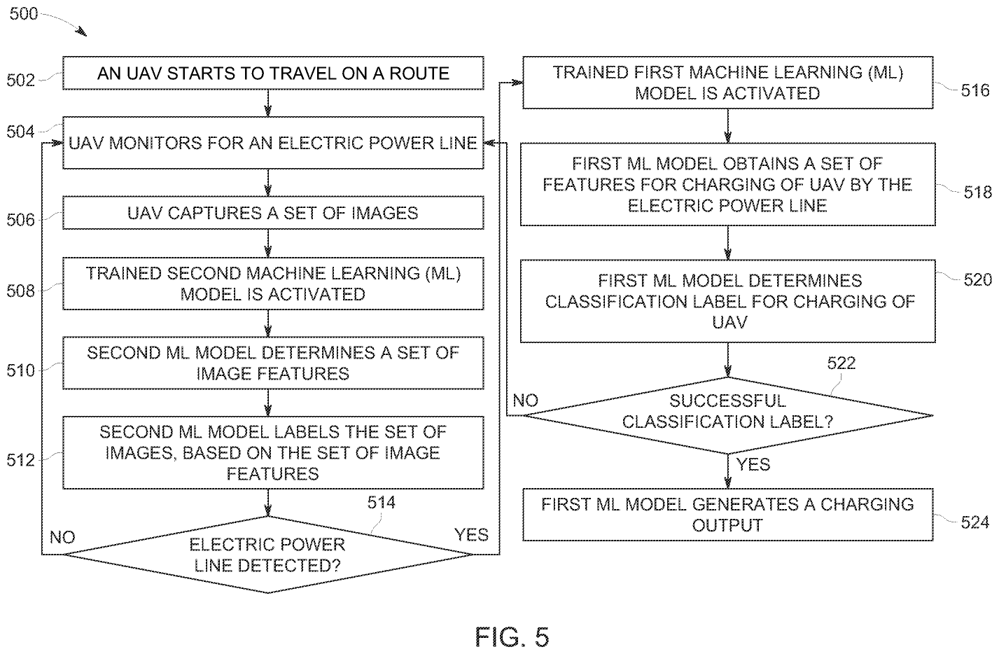

FIG. 5 illustrates an example flowchart for implementation of an exemplary method 500 to charge an UAV, in accordance with an example embodiment. The method 500 to charge an UAV is performed utilizing a first ML model to assign classification label for charging and a second ML model to detect electric power lines for charging. For example, the first ML model and the second ML model may be implemented as a hardware, a software, a firmware, or a combination thereof. In an example, the first ML model and the second ML model may be implemented on a processing resource, such as the processor 202 of the system 102, or the processing server 112a of the mapping platform 112.

At 502, the UAV starts to travel on a route. For example, the route may be defined between a source location and a destination location. In an example, the UAV may be configured to determine the route autonomously, using a mapping and navigation platform. In another example, the route may be fed to the UAV by a user associated with the UAV. In accordance with an example, the UAV may be triggered to travel to perform a delivery operation. In this regard, the UAV may be configured to deliver a cargo to the destination location. It may be noted that the UAV may or may not have sufficient battery charge and battery capacity to complete the delivery operation and return to the source location.

At 504, the UAV monitors for an electric power line for charging. In an example, the UAV may be triggered to monitor for charging based on at least one of map information relating to a location of the UAV, timing information, and battery information associated with the UAV.

At 506, the UAV captures a set of images during the travel. For example, the UAV may capture a first set of images using an imaging source, for example, a camera or camcorder, on-board the UAV. In an example, as the UAV flies or travels, the UAV may collect images in real-time from its camera. In accordance with an example embodiment, the imaging source associated with the UAV may be triggered or activated to capture the first set of images when the battery information associated with the UAV indicates low battery level.

At 508, the trained second machine learning model is activated to determine if an electrical power line is present. For example, the trained second machine learning model is activated to detect presence of an electric power line for charging based on, for example, map data (such as, specific link, tile, location, etc.), certain time of day (such as, during a time when electricity requirement is less, for example, at night), and UAV battery life or charge remaining. In an example, the trained second machine learning model is activated to detect presence of an electric power line when battery life of the UAV is less, i.e., the UAV may not be able to complete the journey, or when the electric demand is not high, such as at night, or when the specific location (such as, tile, road, link, or node) is detected that has an electric power line for charging.

At 510, the trained second ML model may determine a set of image features relating to the first set of images. In this regard, the trained second ML model may determine functional class features associated with the first set of images for detection of electric power lines within the images. Subsequently, the trained second ML model may determine functional class values corresponding to the functional class features for the first set of images. The set of image features may include the functional class features and corresponding functional class values associated with the first set of images.

At 512, the second ML model may label the first set of images, based on the set of image features. For example, the trained second ML model may be trained based on steps 402-406 defined in conjunction with FIG. 4. To this end, the trained second ML model may identify patterns in the labeled historic samples based on corresponding positive and negative sample label, the functional class features, and the functional class values. Further, the second ML model may learn to assign label to unlabeled test sample or other unlabeled samples. In an example, the first set of images, specifically, functional class features and functional class values corresponding to the first set of images may be provided as input to the trained second ML model. The functional class features and functional class values may form unlabeled test sample for labeling. Subsequently, the second ML model may assign a label to the first set of images, for example, each of the first set of images, using the training and learning of the second ML model. For example, on detecting presence of electric power line in an image, the second ML model may assign positive label to the image under consideration. Alternatively, or in addition, on failing to detect presence of electric power line in an image, the second ML model may assign negative label to the image under consideration. Subsequently, the positive label may indicate presence of an electric power line, and negative label may indicate absence of the electric power line.

Once an electric power line is detected for charging at 514, the method 500 may move to 516. However, if an electric power line is not detected at 514 and the UAV is, therefore, not charged, the method 500 may go back to 504 to monitor a different region or area for detecting presence of electric power line. In an example, the UAV may be configured to monitor for electric power line for a predefined time period while travelling. For example, the predefined time period may be one minute, five minutes, seven minutes, ten minutes, and so forth. In another example, a time period for monitoring for electric power line may be dynamically defined based on charge level of the UAV. In an example, when the charge level of the UAV is critically low, the UAV may monitor for electric power line in a region for a few seconds, such as ten seconds, thirty seconds, and so forth. Thereafter, if the UAV fails to find an electric power line to land on and get charged, the UAV may either stop monitoring or monitor a different area after a given time for another few seconds.

At 516, the trained first machine learning model is activated to determine if an electrical power line is capable of charging the UAV. For example, the trained first machine learning model is activated to determine charging capability of the UAV from the electric power line based on, for example, output from the second ML model (such as, when the electric power line is detected by the camera of UAV, using the second ML model), or battery level or charge level of the UAV (such as, when the charge level of battery of the UAV falls below a threshold).

At 518, the trained first machine learning model is configured to obtain a set of features for charging of the UAV by the electric power line. In an example, the trained first machine learning model may access the database 112b and/or other databases associated with the UAV, the system 102 and the mapping platform 112, via a network, to obtain the set of features. The set of features may include a set of UAV attributes and location information relating to the UAV, a set of electric power line attributes relating to the electric power line, and a set of environment attributes relating to environment factors of the charging or landing. In an example, obtaining the set of features includes querying the database 112b for functional class features of each of the labeled training information, unlabeled test information, or a combination thereof as at least one of the set of features.

In an example, the set of features may include functional class features and corresponding functional class values associated with the electric power line, the UAV, and the environment. For example, the functional class features may include, but are not limited to, the set of UAV attributes (e.g., size of the UAV, weight of the UAV, weight and size of a cargo carried by the UAV, battery status of the UAV, battery properties of the UAV, charging adaptor properties of the UAV, altitude, etc.) location information, i.e., geographic location of the UAV, the set of electric power line attributes (e.g., geographic data, power rating, design, number of cables, height, etc.), and the set of environment attributes (e.g., weather, visibility, rain, air traffic density, etc.). Subsequently, example feature class values of the UAV may include, for example, size of UAV as 100 cm in length; weight of UAV as 15 kgs; weight of cargo as 10 kgs; battery status of the UAV as 15% charged; battery properties of the UAV as, Lithium Polymer (LiPo) battery, 3700 mAh battery capacity, 12.6 V charge capacity, etc.; charging adaptor properties of the UAV as 50 W, 100-240V, and 50-60 Hz, and geographic coordinates of the UAV. Example feature class values corresponding to the electric power line may include, but are not limited to, geographic data as corresponding geographic coordinates, and associated node, roads, links, POIs, etc.; power rating as 240V; design as straight, number of cables as three-phase, i.e., 3 cables, and height as 50 meters. Further, example feature class values corresponding to the environment may include, but are not limited to, temperature as 30 degree Celsius; wind data as 15 km/h; humidity as 30%; precipitation as 5%; and visibility as 10 km.

At 520, the trained first ML model is configured to determine classification label for charging of the UAV by the electric power line. In an example, the classification label may be a successful label that indicates that UAV may get successfully charged by landing on the electric power line, or an unsuccessful label that indicates that UAV may not get successfully charged by landing on the electric power line. For example, using the set of features and learning or weights of the trained first ML model, the trained first ML model may assign the classification label to the landing of the UAV on the electric power line for charging.

In accordance with an example embodiment, on determining the environment to be windy or rainy, based on the set of environment attributes, a design of the electric power line to be bowed, based on the set of electric power line attributes, and weight of the UAV and weight of the cargo to be high, the trained first ML model may assign unsuccessful label for charging the UAV by the electric power line. In particular, the trained first ML model may determine that landing a heavy UAV on the bowed electric power line when the environment is windy may be risky as the electric power line may break. In accordance with another embodiment, on determining the environment to be clear, based on the set of environment attributes, a design of the electric power line to be straight, based on the set of electric power line attributes, and weight of the UAV and weight of the cargo to be light, the trained first ML model may assign successful label to the landing. It may be noted that the above-mentioned features for determining classification label for a landing is only exemplary, and in actual implementation of the embodiments of the present disclosure, several other features may have to be considered, such as battery level, charging adaptor configuration, power line service availability, traffic on the power line, time of day, distance from an original route of the UAV, change in delivery time or travel time, and so forth.

Once an electric power line is detected for charging with successful classification label at 522, the method 500 may move to 524. However, if the detected electric power line has unsuccessful label corresponding to it, the first trained ML model may generate a charging output including abort the landing of the UAV on the electric power line. In such a case, the method 500 may go back to 504 to monitor a different region for detecting presence of another electric power line or another power line in the same region or abort monitoring.

At 524, the trained first ML model is configured to generate a charging output associated with the UAV and the electric power line. For example, when the trained first ML model determines the classification label to be successful, the charging output may be generated. In such a case, the charging output may include when and where the UAV may land for charging on the electric power line. For example, the trained first ML model may be stored and run locally on the UAV. Thus, training data and the trained first ML model component may reside on the UAV directly. The trained first ML model provide the UAV with information for landing, such as where (e.g., position or specific location) and when (e.g., time) to land on a specific wire or cable of the electric power line.

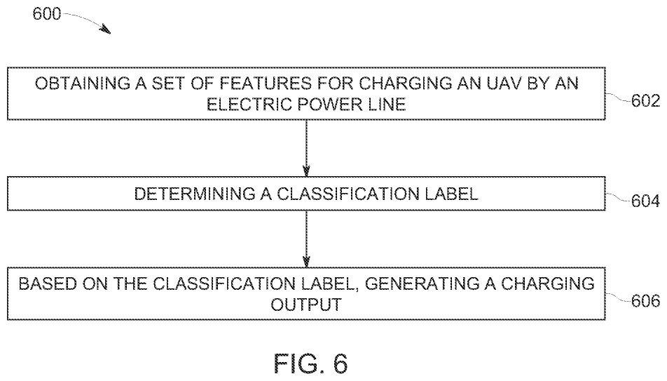

FIG. 6 illustrates an example flowchart for implementation a method 600 to charge an UAV, in accordance with an example embodiment.

At 602, a set of features for charging of the UAV by an electric power line is obtained. The processor 202 may be configured to obtain the set of features including a set of UAV attributes and location information relating to the UAV and a set of electric power line attributes relating to the electric power line. In an example, the set of UAV attributes may include, for example, UAV weight, UAV size, cargo weight, cargo size, charging adaptor properties of the UAV, and current remaining charge in the UAV. Moreover, the set of electric power line attributes may include, for example, voltage level, geolocation, and design (bowed or straight).

At 604, a classification label for charging of the UAV by the electric power line is determined, based on the set of features and a trained first machine learning model. In an example, the processor 202, using the first ML model, may assign one of successful classification label when the electric power line may be used for charging the UAV or an unsuccessful classification label when the electric power line may not be used for charging the UAV.

At 606, a charging output associated with the UAV and the electric power line may be generated, based on the classification label. The processor 202 may generate the charging output to provide landing information to the UAV. In an example, the charging output may include when and where to land to charge the UAV on the electric power line, when the classification label corresponds to the successful label. In another example, the charging output may include to abort charging of the UAV from the electric power line, when the classification label corresponds to an unsuccessful label.

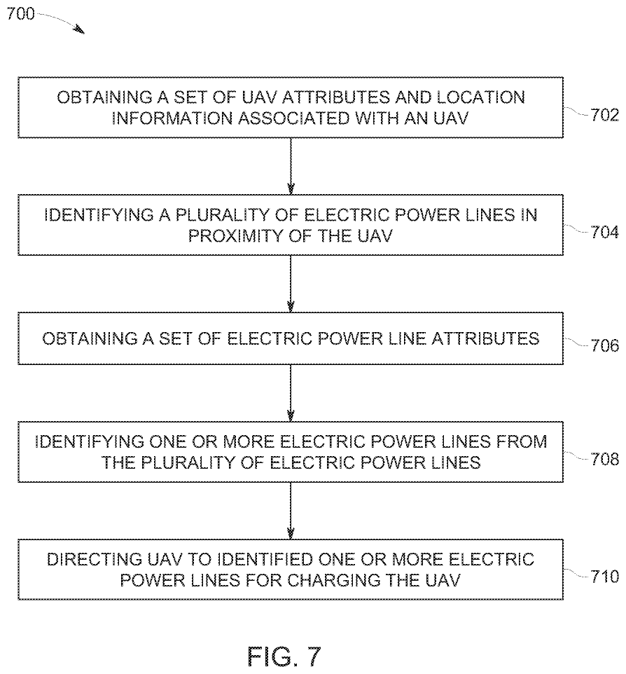

FIG. 7 illustrates an example flowchart for implementation a method 700 to charge an UAV, in accordance with an example embodiment.

At 702, a set of UAV attributes and location information associated with an UAV are obtained. In an example, the set of UAV attributes may include, for example, UAV weight, UAV size, cargo weight, cargo size, charging adaptor properties of the UAV, and current remaining charge in the UAV. Moreover, the location information may indicate a current geographical location of the UAV.

At 704, a plurality of electric power lines in proximity of the UAV is identified based on the location information. In an example, a mapping between the geographical location of the UAV and geographical location of multiple electric power lines is performed. Based on the mapping, the plurality of electric power lines that are in proximity to the UAV are identified.

At 706, a set of electric power line attributes for the plurality of electric power lines are obtained. The set of electric power line attributes for an electric power line may include, for example, voltage level, geolocation, and design (bowed or straight).

At 708, one or more electric power lines from the plurality of electric power lines are identified based on the set of UAV attributes, the set of electric power line attributes and a trained first machine learning model. As described above, the first machine learning model is trained to assign classification label for charging. Subsequently, the trained first machine learning model may assign a classification label for charging the UAV from each of the plurality of electric power lines. In an example, the one or more electric power lines are identified from the plurality of electric power lines based on a set of environment attributes (such as, wind speed, temperature, humidity, etc.). In an example, the trained first machine learning model may assign a successful classification label for charging the UAV by an electric power line when the electric power line can be reliably used for landing and charging, for example, when the electric power line may be able to handle weight of the UAV, transfer charge for charging the UAV, etc. Alternatively, the trained first machine learning model may assign an unsuccessful classification label for charging the UAV by an electric power line when the electric power line cannot be reliably used for landing and charging, for example, when the electric power line may be weak, the weather condition may make the landing of the UAV difficult, the electric power line may not be available for charging or may have fault, etc. To this end, the electric power lines having successful classification label corresponding thereto may be identified as the one or more electric power lines for charging.

At 710, the UAV is directed to the identified one or more electric power lines for charging the UAV. To this end, a distance from original route of the UAV to the one or more electric power lines may be determined. For example, an electric power line having shortest distance from the original route or that may lie on the original route may be selected for charging the UAV. Thereafter, charging output may be generated for directing the UAV to the selected electric power line. In an example, the charging output may include navigation instructions for travelling to the selected electric power line, indication on when and where to land on the electric power line, and indication of a change in the original route of the UAV.

Accordingly, blocks of the methods 300, 400, 500, 600 and 700 support combinations of means for performing the specified functions and combinations of operations for performing the specified functions. It will also be understood that one or more blocks of the methods 30 0, 400, 500, 600 and 7 00, and combinations of blocks in the methods 300, 400, 500 and 600, can be implemented by special purpose hardware-based computer systems which perform the specified functions, or combinations of special purpose hardware and computer instructions.

Alternatively, the system may comprise means for performing each of the operations described above. In this regard, according to an example embodiment, examples of means for performing operations may comprise, for example, the processor 202 and/or a device or circuit for executing instructions or executing an algorithm for processing information as described above.

On implementing the methods 300, 400, 500, 600 and 700 disclosed herein, the end result generated by the system 102 is a tangible application of the charging of the UAV. The charging of the UAV is of utmost importance to ensure enhanced operational time and reliable performance of the UAVs.

Referring again to FIG. 2, the processor 202 may be embodied in a number of different ways. For example, the processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally or alternatively, the processor 202 may include one or more processors configured in tandem via the bus to enable independent execution of instructions, pipelining and/or multithreading. Additionally or alternatively, the processor 202 may include one or more processors capable of processing large volumes of workloads and operations to provide support for big data analysis. In an example embodiment, the processor 202 may be in communication with the memory 204 via a bus for passing information among components of the system 102.

The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the system 102 to carry out various functions in accordance with an example embodiment of the present disclosure. For example, the memory 204 may be configured to buffer input data for processing by the processor 202. As exemplarily illustrated in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an ASIC, FPGA or the like, the processor 202 may be specifically configured hardware for conducting the operations described herein.

Alternatively, as another example, when the processor 202 is embodied as an executor of software instructions, the instructions may specifically configure the processor 202 to perform the algorithms and/or operations described herein when the instructions are executed. However, in some cases, the processor 202 may be a processor specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU) and logic gates configured to support operation of the processor 202. The network environment, such as, 100 may be accessed using the I/O interface 206 of the system 102. The I/O interface 206 may provide an interface for accessing various features and data stored in the system 102.

In some example embodiments, the I/O interface 206 may communicate with the system 102 and displays input and/or output of the system 102. As such, the I/O interface 206 may include a display and, in some embodiments, may also include a keyboard, a mouse, a joystick, a touch screen, touch areas, soft keys, one or more microphones, a plurality of speakers, or other input/output mechanisms. In one embodiment, the system 102 may comprise user interface circuitry configured to control at least some functions of one or more I/O interface elements such as a display and, in some embodiments, a plurality of speakers, a ringer, one or more microphones and/or the like. The processor 202 and/or I/O interface 206 circuitry may be configured to control one or more functions of one or more I/O interface 206 elements through computer program instructions (for example, software and/or firmware) stored on a memory 204 accessible to the processor 202.

In some embodiments, the processor 202 may be configured to provide Internet-of-Things (IoT) related capabilities to users of the system 102 disclosed herein. The IoT related capabilities may in turn be used to provide smart city solutions by providing real time charging output, big data analysis, and sensor-based data collection by using the cloud based mapping system for identifying the electric power line 110 for successful charging and directing the UAV 104 to the identified electric power line 110. The I/O interface 206 may provide an interface for accessing various features and data stored in the system 102.

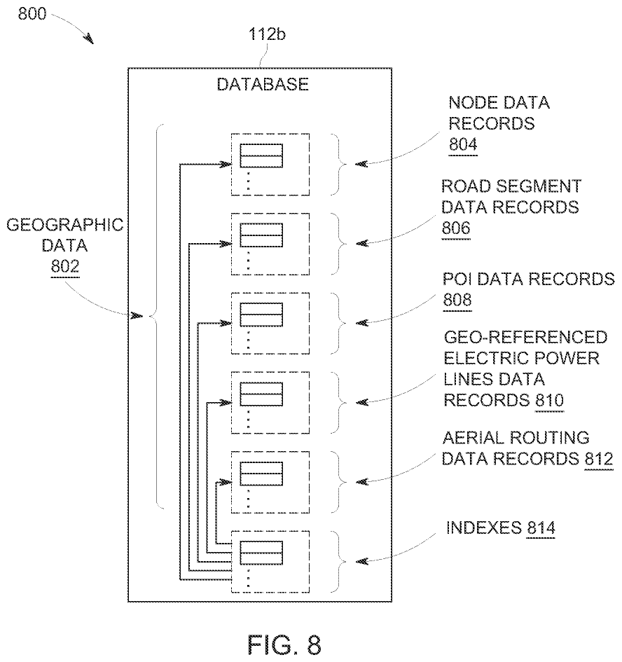

Referring to FIG. 8, an exemplary format 800 of a database 112b capable of storing geographic data for charging predictions is shown, according to one embodiment. In one embodiment, the database 112b includes geographic data 802 used for (or configured to be compiled to be used for) mapping and/or navigation-related services, such as for routing aerial vehicles based on electric power lines for charging

In one embodiment, geographic features (e.g., two-dimensional, or three-dimensional features) are represented using polygons (e.g., two-dimensional features) or polygon extrusions (e.g., three-dimensional features). For example, the edges of the polygons correspond to the boundaries or edges of the respective geographic feature. In the case of an electric power line, a two-dimensional dot or line can be used to represent a footprint of the electric power line, and a three-dimensional polygon extrusion can be used to represent the three-dimensional surfaces of the electric power line. Although various embodiments are discussed with respect to two-dimensional polygons, it is contemplated that the embodiments are also applicable to three-dimensional polygon extrusions, models, routes, etc. Accordingly, the terms polygons and polygon extrusions/models as used herein can be used interchangeably.

In one embodiment, the following terminology applies to the representation of geographic features in the geographic database 121.

“Node”— A point that terminates a link.

“Line segment”— A straight line connecting two points.

“Link” (or “edge”)— A contiguous, non-branching string of one or more line segments terminating in a node at each end.

“Shape point”— A point along a link between two nodes (e.g., used to alter a shape of the link without defining new nodes).

“Oriented link”— A link that has a starting node (referred to as the “reference node”) and an ending node (referred to as the “non reference node”).

“Simple polygon”—An interior region of an outer boundary formed by a string of oriented links that begins and ends in one node. In one embodiment, a simple polygon does not cross itself.

“Polygon”— A region bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the database 112b follows certain conventions. For example, links do not cross themselves and do not cross each other except at a node. Also, there are no duplicated shape points, nodes, or links. Two links that connect each other have a common node. In the database 112b, overlapping geographic features are represented by overlapping polygons. When polygons overlap, the boundary of one polygon crosses the boundary of the other polygon. In the database 112b, a location at which the boundary of one polygon intersects the boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic data 802 of the database 112b includes node data records 804, road segment or link data records 806, POI data records 808, geo-referenced electric power lines data records 810, aerial routing data records 812, and indexes 814. More, fewer, or different data records can be provided. In one embodiment, additional data records (not shown) can include but are not limited to cartographic (“carto”) data records, routing data, maneuver data, map data, and probe data. In accordance with an embodiment, the geo-referenced electric power lines data records 810 can be mapped to an airspace (e.g., an airspace in which aerial vehicles are operating). Accordingly, the database 112b may include additional cartographic data records (not shown) that map or provide map coordinates (or equivalent map representations) of the airspace volumes corresponding to, affected by, and/or otherwise exhibiting the environmental, power line, and airspace factors included in the geo-referenced electric power lines data records 810. For example, these additional cartographic data records may be analogous to the nodes, links, POIs and/or various records 804-808 but extended into the airspace above the ground.

In one embodiment, the indexes 814 may improve the speed of data retrieval operations in the database 112b. In one embodiment, the indexes 814 may be used to quickly locate data without having to search every row in the database 112b every time it is accessed. For example, in one embodiment, the indexes 814 can be a spatial index of the polygon points associated with stored feature polygons.

In exemplary embodiments, the road segment data records 806 are links or segments representing roads, streets, or paths, as can be used in the calculated route or recorded route information for determination of one or more personalized routes. The node data records 804 are end points corresponding to the respective links or segments of the road segment data records 806. The road segment data records 806 and the node data records 804 represent a road network, such as used by UAVs/or other entities. In addition, the database 112b may include road or link segment data records and node data records or other data that represent 3D paths around 3D map features (e.g., terrain features, electric power lines, buildings, other structures, etc.) that occur above street level, such as when routing or representing flight paths of UAVs (e.g., drones).

The road/link segments and nodes can be associated with attributes, such as geographic coordinates, names, address ranges, speed limits, movement restrictions, turn restrictions at intersections, and other navigation related attributes, as well as POIs, such as gasoline stations, hotels, restaurants, museums, stadiums, offices, automobile dealerships, auto repair shops, buildings, stores, parks, etc. The database 112b may include data about the POIs and their respective locations in the POI data records 808. The database 112b may also include data about places, such as cities, towns, or other communities, and other geographic features, such as bodies of water, mountain ranges, etc. Such place or feature data can be part of the POI data records 808 or can be associated with POIs or POI data records 808 (such as a data point used for displaying or representing a position of a city).

In one embodiment, the database 112b may also include geo-referenced electric power lines data records 810 for a digital map data representing geographic coordinates or coordinate-related data, power rating-related data, charging level visualizations, environmental quality data density predictions generated for regions of interest, and related data. In one embodiment, the electric power lines data records 810 can be associated with one or more of the node records 804, road segment records 806, and/or POI data records 808 so that the predicted electric power line for charging may inherit characteristics, properties, metadata, etc. of the associated records (e.g., location, address, POI type, etc.). In one embodiment, the system 102 may use the environmental data density, delivery, and source locations, and/or charging stations visualization and/or prediction to generate aerial vehicles routes for an aerial vehicle, such as drones.

In one embodiment, the system 102 may generate navigation routes using the digital geographic data, map data, probe data and/or real-time data stored in the database 112b based on charging stations visualization and/or predictions. The resulting aerial routing and guidance may be stored in the aerial routing data records 812. By way of example, the routes stored in the aerial routing data records 812 can be created for individual 3D flight paths or routes as they are requested by UAVs for their operators. In this way, previously generated navigation routes can be reused for future UAV travel to the same target location and/or same electric power lien for charging.

In one embodiment, the navigation routes stored in the aerial routing data records 812 can be specific to characteristics of the UAV 104, the cargo 106 (e.g., type of item to be delivered, packaging type) and/or geo-referenced electric power lines characteristics. In addition, the navigation routes generated according to the embodiments described herein can be based on contextual parameters (e.g., time-of-day, day-of-week, season, etc.) that can be used with different environmental quality data density and/or intensity predictions according to the embodiments described herein.

In one embodiment, the database 112b may be maintained by the mapping platform 112, and/or the system 102. The map developer can collect environmental quality data, electric power lines data records and vehicle related data to generate and enhance the database 112b. There can be different ways used by the map developer to collect data. These ways can include obtaining data from other sources, such as municipalities or respective geographic and electric board authorities. In addition, the map developer can employ UAVs or field vehicles (e.g., mapping UAVs or vehicles equipped with mapping sensor arrays, e.g., LIDAR) to travel along roads, flight paths, and/or within buildings/structures throughout the geographic region to observe features and/or record information about them. Also, remote sensing, such as aerial or satellite photography or other sensor data, may be used.

The database 112b can be a master database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, environmental data is compiled (such as into a platform specification format (PSF) format) to organize and/or configure the data for performing navigation-related functions and/or services, such as route calculation, route guidance, map display, speed calculation, distance and travel time functions, and other functions, by a navigation capable device or vehicle, such as by the UAV 104. The navigation-related functions can correspond to 3D flight path or navigation, 3D route planning for package delivery, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for mapping geo-referenced electric power lines for successful charging and generating navigation routes may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A system for charging an unmanned aerial vehicle (UAV), the system comprising:
a memory configured to store computer executable instructions; and
one or more processors configured to execute the instructions to:
obtain a set of UAV attributes and location information associated with the UAV;
identify a plurality of electric power lines in proximity of the UAV, based on the location information;
obtain a set of electric power line attributes for the plurality of electric power lines;
identify one or more electric power lines from the plurality of electric power lines based on the set of UAV attributes, the set of electric power line attributes and a trained first machine learning model; and
direct the UAV to the identified one or more electric power lines for charging the UAV.

2. The system of claim 1, wherein the UAV is directed to the electric power lines which is nearest to an original route of the UAV.

3. The system of claim 1, wherein the one or more electric power lines are identified from the plurality of electric power lines based on a set of environment attributes.

4. The system of claim 1, wherein to train the first machine learning model, the one or more processors are configured to:
receive labeled training information relating to charging of one or more UAVs on one or more electric power lines, the labeled training information including a set of UAV attributes relating to the one or more UAVs, a set of power line attributes relating to the one or more electric power lines, and a set of labels relating to classification of charging;
determine a plurality of features corresponding to charging of the one or more UAVs on the one or more electric power lines, using the labeled training information; and
train the first machine learning model to label one or more unlabeled test information with a classification label for classification of charging, using the plurality of features and the set of labels.

5. The system of claim 4, wherein the set of labels includes one or more ground truth labels including at least one of a successful charging and an unsuccessful charging.

6. The system of claim 1, wherein to obtain the set of features, the one or more processors are configured to query a database for a functional class feature of each of labeled training information, unlabeled test information, or a combination thereof, as at least one of the set of features.

7. The system of claim 4, wherein the trained first machine learning model along with the training information is stored locally on the UAV.

8. The system of claim 1, wherein the one or more processors are further configured to:
receive a first set of images from the UAV;
determine a set of image features relating to the first set of images, using a trained second machine learning model; and
based on the set of image features, label the first set of images with at least one of a positive label for presence of the electric power line and a negative label for absence of the electric power line, in the corresponding first set of images.

9. The system of claim 8, wherein to train the second machine learning model, the one or more processors are further configured to:
receive a set of labeled historic samples, the set of labeled historic samples comprising positive samples and negative samples associated with one or more electric power lines;
determine a set of sample features relating to the set of labeled historic samples; and
based on the set of labeled historic samples and the set of sample features, train the second machine learning model to label one or more unlabeled test samples with at least one of a positive label for presence of an electric power line or a negative label for absence of an electric power line, in the corresponding one or more unlabeled test samples.

10. The system of claim 8, wherein the first set of images is captured by an imaging source associated with the UAV during a travel.

11. The system of claim 10, wherein the one or more processors are further configured to:
trigger the imaging source associated with the UAV to capture the first set of images based on at least one of the location information, timing information, and battery information, associated with the UAV.

12. A method for charging an unmanned aerial vehicle (UAV), the method comprising:
obtaining a set of features for charging of the UAV by an electric power line, the set of features comprising a set of UAV attributes and location information associated with the UAV and a set of electric power line attributes relating to the electric power line;
determining a classification label for charging of the UAV by the electric power line, using the set of features and a trained first machine learning model; and
based on the classification label, generating a charging output associated with the UAV and the electric power line.

13. The method of claim 12, wherein the charging output comprising:
when and where to charge the UAV on the electric power line, when the classification label corresponds to a successful label; and
abort charging of the UAV from the electric power line when the classification label corresponds to an unsuccessful label.

14. The method of claim 12, the method further comprising:
receiving a first set of images from the UAV;
determining a set of image features relating to the first set of images, using a trained second machine learning model; and
based on the set of image features, labeling the first set of images with at least one of a positive label for presence of the electric power line or a negative label for absence of the electric power line, in the corresponding first set of images.

15. The method of claim 14, wherein the first set of images is captured by an imaging source associated with the UAV during a travel.

16. The method of claim 15, the method further comprising:
triggering the imaging source associated with the UAV to capture the first set of images based on at least one of the location information, timing information, and battery information associated with the UAV.

17. A computer programmable product comprising a non-transitory computer readable medium having stored thereon computer executable instructions, which when executed by one or more processors, cause the one or more processors to carry out operations for processing event data, the operations comprising:
receiving labeled training information relating to charging of one or more unmanned aerial vehicles (UAVs) on one or more electric power lines, the labeled training information including a set of UAV attributes relating to the one or more UAVs, a set of power line attributes relating to the one or more electric power lines, and a set of labels relating to classification of charging;
determining a plurality of features corresponding to charging of the one or more UAVs on the one or more electric power lines, using the labeled training information; and
training a first machine learning model to label one or more unlabeled test information with a classification label for classification of charging, using the plurality of features and the set of labels.

18. The computer programmable product of claim 17, the operations further comprising:
obtaining a set of features for charging of an UAV by an electric power line, the set of features comprising a set of UAV attributes and location information associated with the UAV and a set of electric power line attributes relating to the electric power line;
determining a classification label for charging of the UAV by the electric power line, using the set of features and the trained first machine learning model; and
based on the classification label, generating a charging output associated with the UAV and the electric power line.

19. The computer programmable product of claim 17, the operations further comprising:
receiving a set of labeled historic samples, the set of labeled historic samples comprising positive samples and negative samples associated with one or more electric power lines;
determining a set of sample features relating to the set of labeled historic samples; and
based on the set of labeled historic samples and the set of sample features, training a second machine learning model to label one or more unlabeled test samples with at least one of a positive label for presence of an electric power line or a negative label for absence of an electric power line, in the corresponding one or more unlabeled test samples.

20. The computer programmable product of claim 19, the operations further comprising:
storing the trained first machine learning model, the trained second machine learning model along with the labeled training information and the labeled historic samples locally on the UAV.
